(19) United States
(12) Patent Application Publication
(10) Pub. No.: US 2025/0193233 A1
(43) Pub. Date: Jun. 12, 2025

(54) METHOD, SYSTEM, PROGRAM ELEMENT AND COMPUTER-READABLE MEDIUM FOR THE DETECTION OF DDOS ATTACKS IN EMERGENCY NETWORKS

(71) Applicant: Unify Beteiligungsverwaltung GmbH & Co. KG, München (DE)

(72) Inventors: Charalampos Grigoropoulos, Athens (GR); Zisis Tsiatsikas, Thessaloniki (GR)

(21) Appl. No.: 18/969,901

(22) Filed: Dec. 5, 2024

(30) Foreign Application Priority Data
Dec. 8, 2023 (EP) 23 215 272

(51) Int. Cl. H04L 9/40; G06F 18/2413; H04M 3/51

(52) U.S. Cl. CPC H04L 63/1458; G06F 18/2413; H04M 3/5116

(57) ABSTRACT

A method can include detecting, a silent call, monitoring the silent call for the presence of ambient noise, analyzing the ambient noise to identify a specific sound pattern, checking, if there is one or more other parallel silent calls and/or callbacks in one or more Public-safety answering points (PSAPs) of the emergency network, retrieving call location data of the silent call and the one or more other parallel silent call and/or callback, and checking the call location data of the silent call and the one or more other parallel silent call and/or callback for a location pattern for aligning any ambient noise and/or any specific sound pattern with the corresponding location pattern for the silent call and the one or more other parallel silent call and/or callback for use in determining whether a DDoS attack is occurring.

### CROSS-REFERENCE TO RELATED APPLICATIONS

The present application claims priority to European Patent Application No. EP 23 215 272.8, which was filed on Dec. 8, 2023. This application can also be referred to as European Patent Application No. EP 23 215 272. The entirety of European Patent Application No. EP 23 215 272.8 is incorporated by reference herein.

### FIELD

The present invention relates to a method, a system, a program element and a computer-readable medium for the detection of Distributed Denial of Service (DDoS) attacks in emergency networks.

### BACKGROUND

Cyber-attacks and more particularly, attacks on emergency centers can have deadly consequences since they will cause the inability of the agents to respond to emergency requests. In particular, a Distributed Denial of Service (DDoS) attack is a malicious attempt to disrupt the regular functioning of a network, service, or website by overwhelming it with a flood of internet traffic. The basic idea behind a DDoS attack is to exhaust the target's resources such as bandwidth, processing power, or memory making it unable to handle legitimate user requests.

### SUMMARY

Bots, or botnets, can play a crucial role in executing DDoS attacks. A botnet is a network of compromised computers often referred to as “zombies” or “bots” which are controlled by a central entity known as the botmaster. These computers are typically infected with malware allowing the botmaster to remotely control them without the owners' knowledge.

DDoS attacks on emergency requests can have severe consequences and can pose a significant threat to public safety. These attacks target emergency services, such as police, fire departments, medical facilities, or helplines with the intention of disrupting their ability to receive and respond to urgent requests for assistance. The specific problem of DDoS attacks on emergency requests can be understood in the following ways:

Service disruption: DDoS attacks overwhelm the targeted emergency service's infrastructure such as call centers, communication systems, or websites making them inaccessible or significantly degrading their performance. This disrupts the ability of people in distress or facing emergencies to reach out for immediate help.

Delays in response time: DDoS attacks create a congestion of illegitimate traffic that hampers the emergency service's ability to process and handle genuine emergency requests. The increased load on the infrastructure leads to delays in receiving and responding to urgent calls, potentially putting lives at risk.

Loss of critical information: During a DDoS attack, emergency services may experience communication failures or reduced system functionality. This can result in the loss of crucial information such as user location data, medical history, or details of the emergency situation. Without accurate information, emergency responders may face challenges in providing timely and appropriate assistance.

Public safety concerns: Emergency services play a vital role in maintaining public safety and saving lives. When DDoS attacks disrupt their operations, it can have serious consequences. People who are unable to reach emergency services during critical situations may experience increased harm, and the overall public trust in emergency response systems can be undermined.

Resource diversion: Dealing with a DDoS attack requires allocating resources, time, and effort to mitigate the attack and restore normal service operations. This diversion of resources can strain the emergency service's capacity to handle other emergencies efficiently, potentially impacting their ability to respond to simultaneous incidents.

Mitigating the impact of DDoS attacks on emergency requests can require proactive measures. For instance, one such issue with a DDoS attack can be the outbreak of silent calls towards one more public-safety answering point (PSAP) centers from the same or different locations using bots or other computer-based applications. The result will be that the emergency services are flooded with fake calls. As per protocol (NENA Standard for 9-1-1 Call Processing; NENA-STA-020.1-2020, Apr. 16, 2020) “The telecommunicator SHOULD continue to monitor the open line until contact is established or the call is disconnected. If the call is disconnected, the telecommunicator SHOULD attempt to re-establish contact once, at a minimum, to determine if assistance is needed”, the DDoS attack would cause wasted emergency resources and delay in responding to real events.

Embodiments of a method, system, program element and non-transitory computer-readable medium can be provided for the detection of DDoS attacks in emergency networks. Some embodiments can be configured to identify and reject malicious silent calls from being answered or analyzed by emergency services. Some embodiments can also be configured to provide a system for detecting DDoS attacks in emergency networks.

Embodiments can be configured to rely on and/or utilize sound, image/video (optionally) and positioning data of different caller devices or user devices which are taking part in a specific geolocation. For example, the combination of the audio patterns (optional image/video patterns) along with the positioning data can be utilized to reveal if a device acts in a legitimate way or is, instead, part of a DDoS attack. Moreover, embodiments can be configured for the detection of a coordinated fake ambient noise DDoS attack by combining the levels of sound density (e.g., noise types and levels at the said sources) in each of the examined and suspicious devices.

In some embodiments, a method for the detection of Distributed Denial of Service (DDoS) attacks in emergency networks can include:
detecting, by an Emergency Service Routing Proxy (ESRP), of an emergency network, a silent call;
monitoring, by the ESRP, the silent call for the presence of ambient noise;
analyzing, by the ESRP, ambient noise to identify a specific sound pattern in case ambient noise has been detected;
checking, by the ESRP, if there is one or more other parallel silent call and/or callback in one or more Public-safety answering point, PSAP, of the emergency network;
retrieving, by the ESRP, from a provider call location data of the silent call and the one or more other parallel silent call and/or callback within the last k seconds, in case there are one or more other parallel silent call and/or callback;
checking, by the ESRP, the call location data of the silent call and the one or more other parallel silent call and/or callback for a location pattern;
aligning, by the ESRP, any ambient noise and/or any specific sound pattern with the corresponding location pattern for the silent call and the one or more other parallel silent call and/or callback; and
treating, by the ESRP, the silent call according to the standard emergency process, if no alignment has been obtained or treating, by the ESRP, the silent call and/or the one or more other parallel silent call and/or callback as a potential DDoS attack.

An Emergency Service Routing Proxy (ESRP), can be defined as a functional element of the Next Generation (NG) emergency services architecture. For example, an ESRP can be a Session Initiation Protocol (SIP) proxy server that selects next hop routing within the Emergency Services IP Network (ESInet) based on location, service Uniform Resource Name (URN), and policy. An ESInet is a managed Internet Protocol (IP) network used for emergency services communications that can be shared among all public safety agencies or a number of such agencies. Next Generation emergency services can be configured to support multiple media types in addition to other important features such as transmitting location with the call. Embodiments can utilize a signaling layer that supports session management for media types such as audio, video, messaging, and real-time text. The ESRP can be the central entity that monitors PSAP elements for calls which are considered suspicious.

A silent call or an unidentified call can be a call in which the calling party does not speak when the call is answered. A silent call or an unidentified call can be a call type for which the incident type is not known. There is either no sound, or, perhaps, a specific ambient noise that does not make any sense to detect the type of incident, for example. Still, there could be the case that a botnet fakes the background noise in a call in order to mislead the detection mechanisms in the emergency services in a coordinated manner.

It should be appreciated that the term call is not restricted to a pure audio call but includes all other types of media streams that can be used to contact the emergency service to make an emergency call.

An emergency network (for example ESinet), can be a managed IP network that is used for emergency services communications, and which can be shared by all public safety agencies or a number of public safety agencies. It can provide the IP transport infrastructure upon which independent application platforms and core services can be deployed, including, but not restricted to, those used for providing Next Generation 9-1-1/1-1-2 (NG9-1-1/NG1-1-2) services. Emergency networks may be constructed from a mix of dedicated and shared facilities. Emergency networks may be interconnected at local, regional, state, federal, national, and international levels to form an IP-based internetwork (network of networks).

The term aligning, or alignment, can refer to two different data sets that can be matched according to certain criteria, e.g. one data set can be verified by another data set according to certain criteria. For example, if someone is running, this is reflected in a change in geo-position or speed data (first dataset) and at the same time a sound recording (second dataset) of this running person should show a specific sound pattern.

The term standard emergency process can refer to the normal standardized call handling procedure of the emergency service. For example, that every incoming call is answered be an agent of a PSAP or an Interactive voice response (IVR) of the emergency service according to the standard rules foreseen for this purpose.

ECRF (Emergency Call Routing Function) is a functional element which can include a LoST (Location-to-Service Translation) protocol server where location information (either civic address or geo-coordinates) and a Service URN that can serve as input to a mapping function that returns a URI (Uniform Resource Identifier) used to route an emergency call toward the appropriate PSAP for the caller's location or towards a responder agency. LVF (Location Validation Function) is a functional element that can include a LoST protocol server where civic location information is validated against an authoritative database information. A civic address is considered valid if it can be located within the database uniquely, is suitable to provide an accurate route for an emergency call, and adequate and specific enough to direct responders to the right location. BCF (Border Control Function) can provide a secure entry into the emergency network for emergency calls presented to the network. The BCF can incorporate a firewall, admission control, and may include anchoring of session and media as well as other security mechanisms to prevent deliberate or malicious attacks on PSAPs or other entities connected to the network. Emergency service(s) can be a set of services utilized to process an emergency call on an emergency network. It can include, but is not limited to, an ESRP, ECRF, LVF, BCF, Bridge, Policy Store, Logging Services, and typical IP services such as DNS and DHCP.

A provider, which can also be referred to as a carrier, can be a kind of communications service provider (CSP) that provides telecommunications services such as telephony, internet, mobile and data communications access.

The maximum of variable k of seconds can be predefined to allow for a proper investigation of the background calls, etc. In some embodiments, this variable k can take values between 1 to 300 seconds preferably between 20 to 120 seconds and more preferably about 60 seconds.

According to a preferred embodiment, the method can also include:
requesting, by the ESRP, from one or more PSAPs handling one or more silent call from one or more device, image and/or video data of the silent call and the one or more other parallel silent call and/or callback and analyzing, by the ESRP, the image and/or video data for an image and/or video pattern;
aligning, by the ESRP, any ambient noise and/or any specific sound pattern and/or any emergency pattern and/or any image and/or video pattern of the silent call and the one or more other parallel silent call and/or callback with the corresponding location pattern for the silent call and the one or more other parallel silent call and/or callback;
treating, by the ESRP, the silent call according to the standard emergency process, if no alignment has been obtained or treating, by the ESRP, the silent call and/or the one or more other parallel silent call and/or callback as a potential DDoS attack.

The image and/or video data can be obtained from one or more devices which initiates or is responsible for the silent call or other one or more silent call because this is the endpoint(s) examined as potential bot/attack device. The ESRP element requests from the PSAP the relevant stream data, as this is the element which handles the active call. The ESRP does not have an active stream with the device.

In some embodiments, after the step of analyzing ambient noise, the method can also include analyzing, by the ESRP, the specific sound pattern to identify an emergency pattern.

After the step of analyzing the specific sound pattern, the ESRP can verify an identified emergency pattern (e.g. by retrieving, receiving and analyzing additional data regarding the identified emergency pattern from another source).

According to yet another preferred embodiment, the method can include treating, by the ESRP, the silent call according to the standard emergency process, if no other parallel silent call and/or callback is found after the step of checking for one or more other parallel silent call and/or callback in one or more PSAPs of the emergency network.

According to still another preferred embodiment, the other source(s) from which data can be retrieved, received and analyzed, can include social media, smart city sensors, or even meteorological stations which present sudden deviations in the monitored temperature and/or related incident types. The image and/or video correlation with verified information that have been posted on social media may be helpful to identify a fake call.

In some embodiments, the specific sound pattern can include walking sound patterns, running sound patterns, environmental sound patterns, office sound patterns, crowd sound patterns, water or waves sound patterns, traffic sound patterns, alarm sound patterns, extraneous speech sound patterns, bioacoustics sound patterns from animals, and electrical sound patterns from devices such as refrigerators, air conditioning, power supplies, motors and/or weather sound patterns (e.g. rain, thunderstorm).

Further, according to another preferred embodiment, the emergency sound pattern can include weapon shot, alarm, explosion, human screaming, and/or crackling and popping noises when a fire is burning something.

The sound pattern(s) can be audio data that is predefined as being indicative of a pre-specified sound pattern, for example.

A system for the detection of Distributed Denial of Service (DDoS) attacks in emergency networks is also provided. Embodiments of the system can be configured to implement an embodiment of the method.

The system can include one or more Emergency Services Routing Proxies (ESRPs), one or more Public-safety answering points (PSAPs), one or more network service providers, a recorder element which can be configured to monitor and track the stream of emergency calls, a media server may be present in the architecture, and/or a session border controller (SBC).

According to another preferred embodiment, the system can include an application, a software and/or an associated service, wherein the application, the software and/or the associated service support the ESRP in handling, analysis and/or verification of different types of data and/or communication with the different PSAP elements.

According to yet another aspect of the present invention, a program element is provided which when being executed by a processor is adapted to carry out steps of an embodiment of the method for the detection of DDoS attacks in emergency networks. The program element can include code that is stored in a non-transitory computer readable medium that can be run by a processor that is communicatively connectable to the computer readable medium so a device having the processor performs the method defined by the code, for example.

A non-transitory computer-readable medium comprising program code can also be provided. The code can be stored in the non-transitory computer-readable medium so that it can be executed by a processor so a device of the processor can carry out steps of the method for the detection of DDoS attacks in emergency networks.

A non-transitory computer-readable medium may be a floppy disk, a hard disk, a USB (Universal Serial Bus) storage device, a RAM (Random Access Memory), a ROM (read only memory) or an EPROM (Erasable Programmable Read Only Memory). A computer-readable medium may also be a data communication network, e.g. the Internet, which may allow downloading a program code.

It has also to be noted that aspects of the invention have been described with reference to different subject-matters. In particular, some aspects or embodiments have been described with reference to apparatus type claims whereas other aspects have been described with reference to method type claims. However, a person skilled in the art will gather from the above and the following description that, unless otherwise notified, in addition to any combination between features belonging to one type of subject-matter also any combination between features relating to different types of subject-matters is considered to be disclosed with this text. In particular, combinations between features relating to the apparatus type claims and features relating to the method type claims are considered to be disclosed.

### BRIEF DESCRIPTION OF THE DRAWINGS

The invention and embodiments thereof will be described below in further detail in connection with the drawing(s).

FIG. 1 schematically shows a flowchart of a basic sequence diagram of a method according to an exemplary embodiment of the invention.

FIG. 2 schematically shows a flowchart or a pocket call scenario according to another exemplary embodiment of the invention.

FIG. 3 schematically shows a flowchart of a Location, Noise and Imaging/Video analysis according to another exemplary embodiment of the invention.

FIG. 4 schematically shows a flowchart of a DDoS scenario with silent calls and ambient noise according to another exemplary embodiment of the invention.

### REFERENCE NUMERALS USED IN THE DRAWINGS INCLUDE

DDoS attack Distributed Denial of Service attack
ESRP Emergency service routing proxy
PSAP Public-safety answering point
N variable natural number
RTP Stream Real-time transport protocol stream
t1, t2 timeframes 1 and 2
k time variable
z three-dimensional axis
S100-S1100 method steps S100-S1100

### DETAILED DESCRIPTION

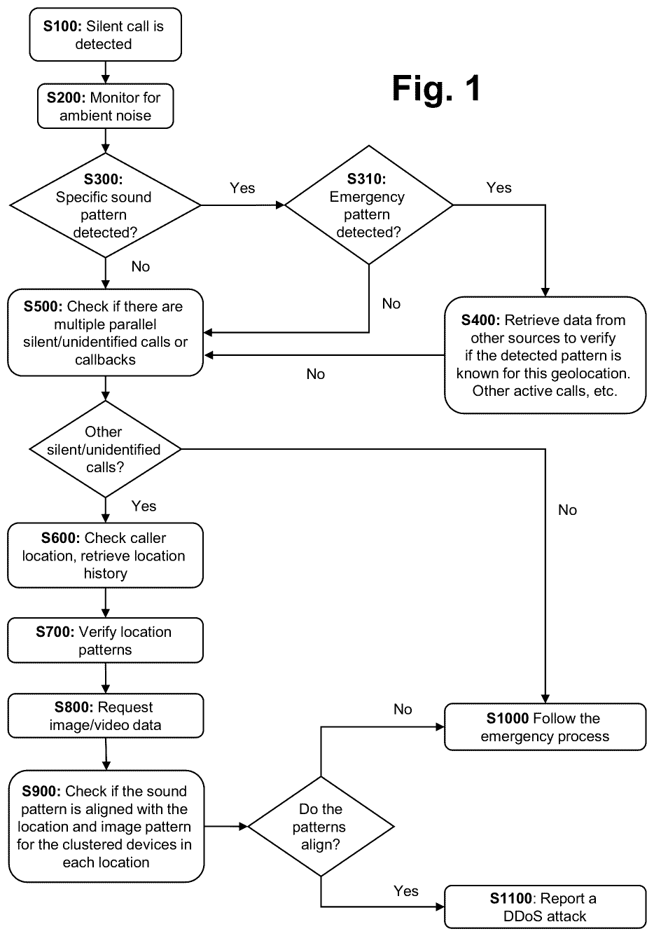

In FIG. 1, a basic sequence diagram of an exemplary embodiment of a method according to an embodiment of the invention is depicted. In a first step S100, a silent/unidentified call is detected in the emergency service, more specific in the ESRP. In some embodiments, this detection can be done using a SUBSCRIBE/NOTIFY mechanism between the ESRP and the PSAP elements. That is, the ESRP subscribes on the PSAP element for a silent/special-type call. When the PSAP element identifies a silent stream, then it sends a NOTIFY to the ESRP element that there is one or more relevant calls. Then the ESRP requests from the PSAP element the relevant stream data for the examined call. It should be noted that the same approach would be followed in case an interactive voice response IVR answers the call in the PSAP side.

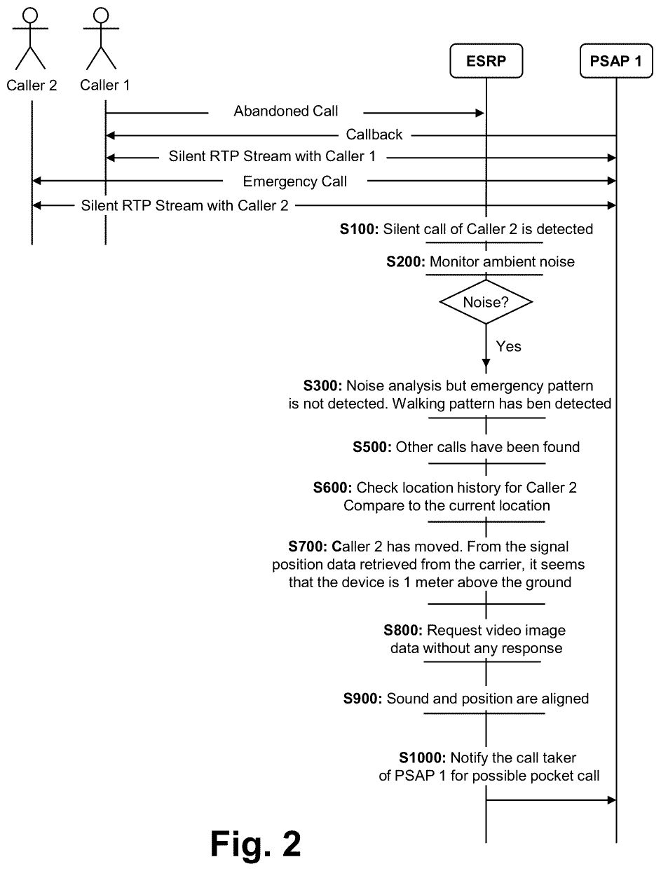

The SUBSCRIBE/NOTIFY mechanism works in the same way. A silent/unidentified call can be a call type for which the incident type is not known. There is either no sound, or, perhaps, a specific ambient noise that does not make any sense to detect the type of incident. Still, there could be the case that a botnet fakes the background noise in order to mislead the detection mechanisms in the emergency service in a coordinated manner. Embodiments can be configured to address all the above-mentioned scenarios. Further, embodiments can also be configured to account for the case of accidental pocket calls which may be accidentally established with the emergency service and create frustration (see. FIG. 2 for more details).

In step S200, the ESRP monitors the call stream for the detection of ambient noise. If ambient noise is found, then an analysis of this noise is performed in step S300 by the ESRP or associated services to identify a specific sound pattern. For example, such pattern can be a specific emergency pattern or a walking or running sound pattern or a sound pattern typically for an office or a crowded atmosphere like a marketplace etc. The focus in step S310 can be to detect a specific emergency pattern that will probably reveal an emergency incident, for example, an explosion, gun shots etc. The analyzed sound pattern(s) can be pre-defined to facilitate identification of audio data that can provide an output of audio that has a pre-selected sound pattern (e.g. walking, running, explosions, etc.).

Then, in step 400 in case an emergency pattern has been identified, other data is retrieved, received and used by the ESRP to verify the emergency pattern in the geolocation of the call. Thus, for example, if an explosion was identified by the emergency stream, other active calls, social media postings, etc. are retrieved from other sources like social media, smart city sensors, or even meteorological stations which present sudden deviations in the monitored temperature, and used to identify if the detected incident pattern is verified.

In step S500, in case an emergency pattern was not detected or in case it has not been verified by data of other sources, then the emergency service checks if there are multiple parallel silent/unidentified calls or callbacks in the same or other PSAP call centers associated with the ESRP. In case there are no parallel silent/unidentified calls or callbacks present then the emergency service follows the standard handling process by trying to establish a direct contact with the caller and an agent or IVR of the emergency service. However, if there is a parallel action that is detected that aims on consuming the emergency service resources by using silent/unidentified active calls, this can be detected via the event other multiple silent or unidentified calls or callbacks at the same or other PSAP call center is detected. A pre-selected threshold of a number of such calls can be set to help identify or detect a DDoS attack by such checking performed by the emergency service.

In some embodiments, if there is one or more parallel silent/unidentified call detected in step S500 then in step S600 (e.g. the number of identified other such calls meets or exceeds a pre-selected threshold), the emergency service collects location data from the provider for the last k seconds for this one or more parallel silent/unidentified call.

In step S700, the retrieved location data from the provider can be used in order to identify a motion pattern. For example, the location data can reveal that there is a static, or a walking, or a running pattern. This can be simply calculated by computing the differences between the different x, y, z coordinates over the k seconds time span retrieved from the provider. If the parallel silent/unidentified call data has been found to have moved the last k seconds, then there is a high chance that this is not a bot or an infected machine.

As an additional optional measure, the emergency service requests in step 8800 image/video data from the PSAP. Another approach that can be utilized instead of or in conjunction with such image/video data collection can be to request the data from smart city cameras or sensors if those are installed in the examined geolocation to obtain such data as well, or as an alternative.

In step S900, all the previously retrieved data of audio, image/video and/or positioning data are combined by the emergency service in order to verify that the identified patterns are aligned. For example, if location data show a movement of 4 km/h, then this should also be aligned with the sound pattern that is probably obtained from this device's microphone. Additionally, if video data have been retrieved, these should be also aligned. And these requirements should be met for all the devices which initiate silent/unidentified calls/streams on the emergency service in the same examined timeframe. A last aspect touched by the proposed method, concerns the alignment of the different sound sources, compared with the relevant positioning data as described above, taking into account that a set of infected bot devices would be assigned the difficult task to replay a fake ambient noise in a way that can deceive the emergency service. This would not be so easy to achieve by an infected device.

Finally, if the emergency service decides upon all the information from the provided data, analysis and alignment of these data that there is no alignment, then in step S1000, the call is processed in accordance with the usual emergency service call processing, meaning a call agent and/or an IVR of the emergency service will handle the call. However, if there is an alignment of the provided data, then in step S1100, the emergency service will report a DDoS attack.

In FIG. 2 a flowchart of a pocket call scenario is shown. This scenario describes the case of a pocket call. Pocket call (also known as pocket dialing or butt dialing) is the accidental placement of a phone call while a person's mobile phone or cordless phone is in the owner's pocket or handbag. The recipient of the call typically hears random background noise when answering the phone. In this case, a user device accidentally initiates an emergency call to the emergency service.

In step S100, a silent call is detected from Caller 2 by the ESRP in PSAP 1. By the term silent it is meant that the user is not responding/talking.

In step S200, the emergency service monitors for the presents of ambient noise and detects the presence of an ambient noise. In the next step S300, an audio analysis is performed by the emergency service. This analysis reveals a specific pattern but not an emergency pattern. This specific pattern in this case is, for example, a walking pattern. Thereby, the audio analysis is executed using, for example, Algermissen, S.; Hörnlein, M. Person Identification by Footstep Sound Using Convolutional Neural Networks. Appl. Mech. 2021, 2(2), 257-273 (https://doi.org/10.3390/applmech2020016) and similar methods. In this case, no additional data is used from other sources like social media, etc., although this could of course also be done here.

Then in step S500, one additional parallel silent/unidentified call (abandoned call and callback regarding Caller 1) is present in the same (PSAP 1) or other PSAP so there is an indication that this could be part of a DDoS attack.

In step S600 and step S700, the emergency service retrieves from the provider the location history for Caller 2 for the last 500 seconds (e.g. one value per 5 seconds). The provider returns a set of 3D position points. Based on simple calculations (e.g. placing the position values on a map), the emergency service identifies that the user device of Caller 2 was moving for the last 120 seconds and this movement is also aligned with the audio analysis. Such analysis is depicted, for example, in Algermissen, S.; Hörnlein, M. PersonIdentification by Footstep Sound Using Convolutional Neural Networks. Appl. Mech. 2021, 2(2), 257-273 and Jürgen T. Geiger, Maximilian Kneiβl, Björn Schuller and Gerhard Rigoll. Acoustic Gait-based Person Identification using Hidden Markov Models. 2014 (https://doi.org/10.48550/arXiv.1406.2895). According to the 3D positioning data, it seems that the user device is located, on average, at a height of around 1 meter above the ground.

In step 8800, the emergency service requests video image data from the open, stream for example, through audio commands. In this case, there is no response.

Then in step S900, the emergency service tries to align the sound and location/position patterns. It is found that the audio pattern of someone walking is verified from the positioning data and the walking pace is also verified. Verification can be performed, for example, according to U.S. Pat. No. 10,572,723.

In step S1000, a notification is sent to the call taker (agent in the PSAP 1) that indicates that the examined call is probably a pocket call. However, due to the NENA or EENA regulations, the responsible PSAP agent must in any case make a callback to finally clarify the situation.

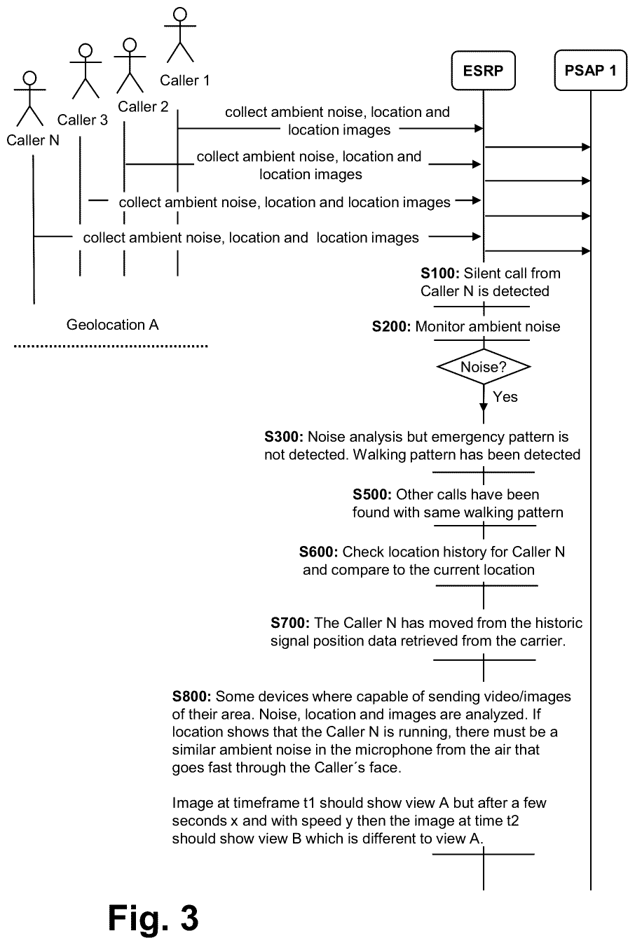

In FIG. 3, a flowchart of a location, noise and imaging/video analysis according to another embodiment of the invention is shown. In this scenario, the data from the ambient noise, the location data and the image and/or video data (step 8800) of other callers or devices (Caller 1, 2, 3, N) are collected. Then these data are combined in a way to prove that the generated sound and image in each device can be related with the location pattern. Example studies that do such comparisons are, for example, Sascha Heyer, Towards Data Science, April 2022, https://towardsdatascience.com/image-similarity-with-deep-learning-c17d83068f59 and Robert Wood, “Calculating Speed using Video Analysis.” Topend Sports Website, May 2010, https://www.topendsports.com/biomechanics/video-analysis-speed.htm, accessed 21 Oct. 2023.

For example, if a caller (device) is running with 4 km/h, this should create a specific pattern in the device's microphone. In order to find out, if the wind speed is indeed produced from the input sound, this can be simply done by correlating the positioning data of the device with the sound perceived in the microphone as it is described in U.S. Pat. No. 9,343,056. If these pieces of information match, the device is then considered to act normally. On the other hand, if it is found, e.g. five devices whose imaging is not in sync with the retrieved speed/location they will get blacklisted and marked as potential DDoS attack. Of course, this output should also be correlated with the fact that other devices act in the same way in the same geolocation.

In particular, in step 8800, some devices where capable of sending video/images of their area. Noise, location and images are analyzed. If location shows that the Caller N is running, there must be a similar ambient noise in the microphone from the air that goes fast through the Caller's face. Thus, the image at timeframe t1 should show view A but after a few seconds (3-180 seconds) and with a certain speed (e.g. 4 km/h) then the image at timeframe t2 should show view B which is different to view A. This could be done for example if the location of the pictures comprise metadata, so it is very straight forward to identify that the location is different and it has been covered in the relevant speed identified by the sound sample.

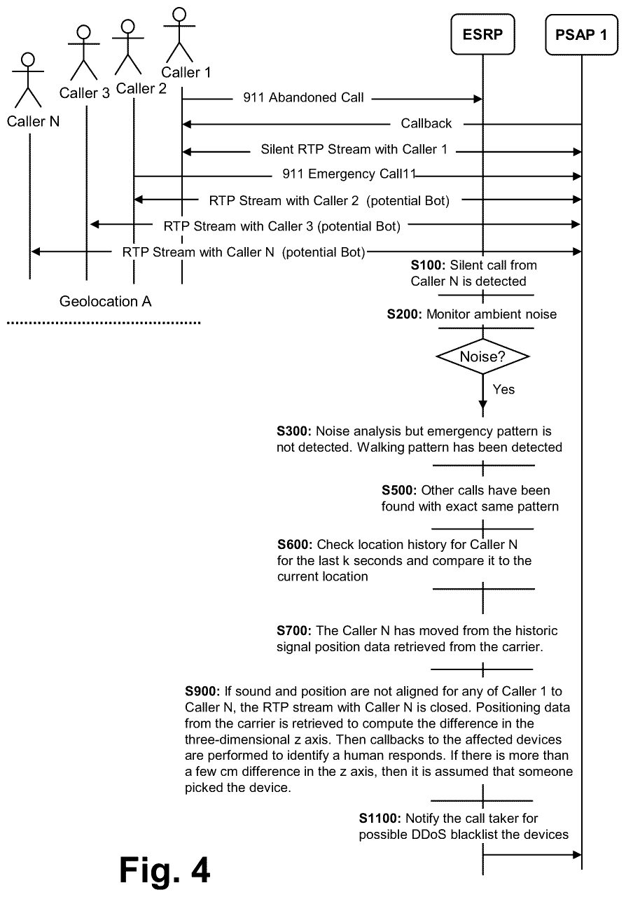

In FIG. 4 a flowchart of a DDoS scenario with silent calls and ambient noise according to another embodiment of the invention is depicted. In this scenario, bots (Bot 1, Bot 2, Bot N) try to fake an ambient noise in a coordinated manner. The point is to deceive the emergency service regarding (1) the incident type, or (2) the conditions of the incident. It is assumed that the devices are located in a close position, with a distance between them varying from r to m, and the ambient noise pattern is the same. From the two following references, it is easily perceivable that even a very loud source, like for example 110 db, will be perceived as a normal level discussion if it is reduced in the level of 70 db. This means that a distance of approx. 30-60 meters (r to m) have to be covered. The level of sound perceived by the bot devices its crucial because the lowest the sound level, the more the vague sound that is perceived by the devices, the longer the distance that the sound comes from, and the bigger the area that needs to be evaluated by the emergency service for potential incidents that need to be crosschecked. From the attacker perspective, these would be the different factors taken into account to launch a successful botnet attack as described in this document. 1. https://decibelpro.app/blog/decibel-chart-of-common-sound-sources/2.https://www.sweetwater.com/insync/inverse-square-law/#:˜:text=Useful %20when %20setting %20up %20a,of %20distance %20from %20the %20source. The sound pattern recognition can be achieved using, for example, the method described in Ketan Doshi, “Audio Deep Learning Made Simple: Sound Classification, Step-by-Step”, Towards Data Science, March 2021, https://towardsdatascience.com/audio-deep-learning-made-simple-sound-classification-step-by-step-cebc936bbe5. The issue here is that the bots will not easily be able to play the fake ambient noise in a correct way. This is because some devices may be closer to the sound source and others could be far away. Thus, the perceived level of sound should not be the same.

Upon detecting in step S900 that all suspicious devices have the same ambient background noise, the emergency service will identify the level of ambient noise in each device. This can be achieved using, for example, U.S. Patent Application Publication No. 2018/0167677 A1. The emergency service will compare the ambient noise levels and based on the devices locations it will infer if the devices (aka the bots) are acting maliciously. Among the different devices, the one which has the maximum ambient noise will be used as a reference, because it is considered to be closer to the sound source. All other devices should receive the corresponding level of sound, based on the teachings of https://www.acoustical.co.uk/distance-attenuation/how-sound-reduces-with-distance-from-a-point-source/. So, if, for example, the maximum ambient noise is perceived in a first device at a level of 40 dB, and this is the maximum between all the devices, then it should be perceived accordingly by the rest of the devices as well. From the provider the emergency service knows the positioning data and thus, it is easily decided which device should receive approximately what level of the same ambient noise level. The approximation is due to the fact that noise levels may be affected by obstacles. But even with this parameter in mind, it is not possible for a second device which is at a 6 m distance from the first device to perceive more than a third device which is at 2 m distance from the first device. The botnet should act in a very intelligent way to overcome this barrier, and this would most probably compromise the silent activity of a malicious software running in a mobile device.

In such a case, the proposed method will be used as in the previous embodiments, but with the difference that in step S500 other calls are found having the exact same pattern. The proposed method collects data for N calls by just identifying the walking pattern. Where N is a natural number.

In step S600, the data from the provider are retrieved regarding the examined device for the last k seconds.

In step S700, it is identified that the difference of the data infers a movement and thus it is identified that the caller (aka the corresponding device) has moved.

In step 8800, the emergency service asks the PSAP element to provide video/image data which are originated from the examined caller (aka the corresponding device of the caller), but there is no response.

In step S900, it is identified that based on the positioning data, the examined caller (aka the corresponding device of the caller) is moving very fast with a running pace (described, for example, in U.S. Pat. No. 10,572,723), whereas the audio pattern indicates that the caller walks (described, for example, in U.S. Pat. No. 9,343,056 and Algermissen, S.; Hörnlein, M. Person Identification by Footstep Sound Using Convolutional Neural Networks. Appl. Mech. 2021, 2(2), 257-273). Similar inconsistency is detected for the other parallel silent calls.

The emergency service hangs up the calls and performs a callback to the callers. Prior to this action, the emergency service checks the network coverage of the caller (e.g. disclosed in https://www.gsma.com/coverage/ and https://www.nperf.com/en/map/5g) and the load in the corresponding antenna by requesting the load level from the provider, in order to avoid a situation in which the user cannot be contacted again. If this is the case, the emergency service closes the session and performs a callback to the caller. If the caller responds to the callback by a call taker (agent of a PSAP) or an IVR of the emergency service, the emergency service retrieves data from the provider for the last k seconds to identify if there is a change of the device in three-dimensional axis z, for example, in a few cm. If this is aligned with the user's response (meaning that a human voice response can be recognized), then it is an indication that a caller has responded and not a bot. Variable k can take values between 1 to 300 seconds, preferably between 20 to 120 seconds, more preferably about 60 seconds.

The same procedure is also followed for the rest of the suspicious calls considered as silent/unidentified.

In the last step S1100, the call taker is notified about the unverified calls and the possible DDoS incident.

It should be appreciated that a PSAP and ESRP are each types of devices that include hardware. Each PSAP and each ESRP can include a processor connected to a non-transitory memory and at least one transceiver unit, for example. These devices can each also include or be communicatively connected to at least one input device, at least one output device, and/or at least one input/output device. The ESRP can be communicatively connected to one or more PSAPs and each PSAP can be communicatively connected to an ESRP.

Each caller device can be a type of telecommunication endpoint device (e.g. laptop computer, desktop computer, tablet, smart phone, telephone, etc.). Each bot can be a type of device that runs at least one program to define bot functionality of the device. Embodiments of the system and method can be utilized in machine environments for telecommunication systems or telecommunication devices, for example.

It should be noted that the term “comprising” does not exclude other elements or steps and the “a” or “an” does not exclude a plurality. Further, elements described in association with different embodiments may be combined.

It should also be noted that reference signs in the claims shall not be construed as limiting the scope of the claims.

It should also be appreciated that different embodiments of the method, communication system, communication apparatus, and non-transitory computer readable medium can be developed to meet different sets of design criteria. For example, the particular type of network connection, server configuration or client configuration for a device for use in embodiments of the method can be adapted to account for different sets of design criteria. As yet another example, it is contemplated that a particular feature described, either individually or as part of an embodiment, can be combined with other individually described features, or parts of other embodiments. The elements and acts of the various embodiments described herein can therefore be combined to provide further embodiments. Thus, while certain exemplary embodiments of a telecommunication apparatus, telecommunication device, computer device, a network, a server, a communication system, and methods of making and using the same have been shown and described above, it is to be distinctly understood that the invention is not limited thereto but may be otherwise variously embodied and practiced within the scope of the following claims.

What is claimed is:

1. A method for the detection of Distributed Denial of Service (DDoS) attacks in emergency networks, the method comprising:
detecting, by an Emergency Service Routing Proxy (ESRP) of an emergency network, a silent call;
monitoring, by the ESRP, the silent call for the presence of ambient noise;
analyzing, by the ESRP, the ambient noise to identify a specific sound pattern in case ambient noise has been detected;
checking, by the ESRP, whether there is one or more other parallel silent calls and/or callbacks in one or more Public-safety answering points (PSAPs) of the emergency network;
retrieving, by the ESRP, call location data of the silent call and the one or more other parallel silent calls and/or callbacks within the last k seconds from a provider after determining that there are one or more other parallel silent calls and/or callbacks;
checking, by the ESRP, the call location data of the silent call and the one or more other parallel silent calls and/or callbacks for a location pattern;
aligning, by the ESRP, any ambient noise and/or any specific sound pattern with the corresponding location pattern for the silent call and the one or more other parallel silent calls and/or callbacks;
treating, by the ESRP, the silent call according to the standard emergency process after it is determined that no alignment has been obtained or treating, by the ESRP, the silent call and/or the one or more other parallel silent calls and/or callbacks as a potential DDoS attack after it is determined that there is alignment of the ambient noise and/or any specific sound pattern with the corresponding location pattern for the silent call and the one or more other parallel silent calls and/or callbacks.

2. The method of claim 1, wherein the method further comprising the steps of:
requesting, by the ESRP, from one or more PSAPs, image and/or video data of the silent call and the one or more other parallel silent calls and/or callbacks and analyzing, by the ESRP, the image and/or video data for an image and/or video pattern; and
wherein the aligning, by the ESRP, of any ambient noise and/or any specific sound pattern with the corresponding location pattern for the silent call and the one or more other parallel silent calls and/or callbacks includes aligning any emergency pattern and/or any image and/or video pattern of the silent call and the one or more other parallel silent calls and/or callbacks with the corresponding location pattern for the silent call and the one or more other parallel silent calls and/or callbacks.

3. The method of claim 1, comprising:
analyzing, by the ESRP, the specific sound pattern to identify an emergency pattern after the analyzing of the ambient noise.

4. The method of claim 1, comprising:
verifying, by the ESRP, an identified emergency pattern by retrieving, receiving and analyzing additional data regarding the identified emergency pattern form another source after the analyzing the specific sound pattern.

5. The method of claim 4, comprising:
treating, by the ESRP, the silent call according to the standard emergency process, if no other parallel silent call and/or callback is found after the step of checking for one or more other parallel silent call and/or callback in one or more PSAPs of the emergency network.

6. The method of claim 4, wherein the other source comprises social media, smart city sensors, and/or meteorological stations.

7. The method of claim 1, wherein the specific sound pattern comprises walking sound patterns, running sound patterns, environmental sound patterns, office sound patterns, crowd sound patterns, water or waves sound patterns, traffic sound patterns, alarm sound patterns, extraneous speech sound patterns, bioacoustics sound patterns from animals, and electrical sound patterns from devices such as refrigerators, air conditioning, power supplies, motors and/or weather sound patterns.

8. The method of claim 1, wherein the emergency sound pattern comprises weapon shot, alarm, explosion, human screaming, and/or crackling and popping noises when a fire is burning something.

9. A system for the detection of a Distributed Denial of Service (DDoS) attack in emergency networks, wherein the system includes an Emergency Service Routing Proxy (ESRP), the ESRP configured to:
detect a silent call;
monitor the silent call for the presence of ambient noise;
analyze the ambient noise to identify a specific sound pattern;
check whether there is one or more other parallel silent calls and/or callbacks in one or more Public-safety answering points (PSAPs) of the emergency network to which the ESRP is communicatively connectable;
retrieve call location data of the silent call and the one or more other parallel silent calls and/or callbacks within the last k seconds from a provider after determining that there are one or more other parallel silent calls and/or callbacks;
check the call location data of the silent call and the one or more other parallel silent calls and/or callbacks for a location pattern;
align any ambient noise and/or any specific sound pattern with the corresponding location pattern for the silent call and the one or more other parallel silent calls and/or callbacks; and
treat the silent call and/or the one or more other parallel silent calls and/or callbacks as a potential DDoS attack after it is determined that there is alignment of the ambient noise and/or any specific sound pattern with the corresponding location pattern for the silent call and the one or more other parallel silent calls and/or callbacks.

10. The system of claim 9, also comprising:
one or more Public safety answering points (PSAP) communicatively connected to the ESRP.

11. The system of claim 10, also comprising:
one or more network service providers;
a recorder element which is used to monitor and track emergency calls,
a media server, and/or
an session border controller (SBC).

12. The system of claim 9, wherein the ESRP has an application, a software and/or an associated service that supports handling, analysis and/or verification of different types of data and/or communication with the different PSAP elements.

13. A non-transitory computer-readable medium comprising program code which, when being executed by a processor, is adapted to carry out steps of a method for the detection of Distributed Denial of Service (DDoS) attacks in emergency networks, the method comprising:
detecting a silent call;
monitoring the silent call for the presence of ambient noise;
analyzing the ambient noise to identify a specific sound pattern;
checking whether there is one or more other parallel silent calls and/or callbacks in one or more Public-safety answering points (PSAPs) of an emergency network;
retrieving call location data of the silent call and the one or more other parallel silent calls and/or callbacks within the last k seconds from a provider after determining that there are one or more other parallel silent calls and/or callbacks;
checking the call location data of the silent call and the one or more other parallel silent calls and/or callbacks for a location pattern;
aligning any ambient noise and/or any specific sound pattern with the corresponding location pattern for the silent call and the one or more other parallel silent calls and/or callbacks; and
treating the silent call and/or the one or more other parallel silent calls and/or callbacks as a potential DDoS attack after it is determined that there is alignment of the ambient noise and/or any specific sound pattern with the corresponding location pattern for the silent call and the one or more other parallel silent calls and/or callbacks.

14. The non-transitory computer-readable medium of claim 13, the method also, comprising:
verifying an identified emergency pattern by retrieving, receiving and analyzing additional data regarding the identified emergency pattern form another source after the analyzing the specific sound pattern.

15. The non-transitory computer-readable medium of claim 14, wherein the other source comprises social media, smart city sensors, and/or meteorological stations.

16. The non-transitory computer-readable medium of claim 13, wherein the specific sound pattern comprises walking sound patterns, running sound patterns, environmental sound patterns, office sound patterns, crowd sound patterns, water or waves sound patterns, traffic sound patterns, alarm sound patterns, extraneous speech sound patterns, bioacoustics sound patterns from animals, and electrical sound patterns from devices such as refrigerators, air conditioning, power supplies, motors and/or weather sound patterns.

17. The non-transitory computer-readable medium of claim 13, wherein the emergency sound pattern comprises weapon shot, alarm, explosion, human screaming, and/or crackling and popping noises when a fire is burning something.
